(19) United States
(12) Patent Application Publication
(10) Pub. No.: US 2026/0034847 A1
(43) Pub. Date: Feb. 5, 2026

(54) VEHICLE THERMAL MANAGEMENT SYSTEM

(71) Applicants: Hyundai Motor Company, Seoul (KR); Kia Corporation, Seoul (KR)

(72) Inventor: Jong Won KIM, Hwaseong-Si (KR)

(73) Assignees: Hyundai Motor Company, Seoul (KR); Kia Corporation, Seoul (KR)

(21) Appl. No.: 18/959,165

(22) Filed: Nov. 25, 2024

(30) Foreign Application Priority Data
Jul. 30, 2024 (KR) 10-2024-0100945

(51) Int. Cl. B60H 1/00; B60H 1/32

(52) U.S. Cl. CPC B60H 1/00278; B60H 1/00885; B60H 1/3227; B60H 2001/00307; B60H 2001/00928

(57) ABSTRACT

A vehicle thermal management system includes a refrigerant system configured to cause, while refrigerant circulates along a refrigerant line, the refrigerant to sequentially pass through an external condenser and a first expansion valve, a component thermal management system including a battery or a power electric (PE) component connected by a coolant line and configured to perform, using the refrigerant distributed from the refrigerant system and coolant circulating along the coolant line, thermal management on the battery or the power electric (PE) component, and a heat-exchanger including a heat-exchange portion connected to the coolant line and provided to allow the coolant circulating through the component thermal management system to pass through the heat-exchange portion, wherein the heat-exchanger is provided on the refrigerant line between the external condenser and the first expansion valve and performs heat-exchange between the coolant passing through the heat-exchange portion and the refrigerant injected from the refrigerant line.

### CROSS-REFERENCE TO RELATED APPLICATION

The present application claims priority to Korean Patent Application No. 10-2024-0100945, filed on Jul. 30, 2024, the entire contents of which is incorporated herein for all purposes by this reference.

### BACKGROUND OF THE PRESENT DISCLOSURE

### Field of the Present Disclosure

The present disclosure relates to a vehicle thermal management system configured not only to employ a gas injection heat pump system for vehicle interior heating, vehicle interior cooling, battery cooling, and the like, but also to perform additional heat dissipation in response to an increase in heat load of a vehicle.

### Description of Related Art

Recently, with electrification of vehicles, thermal management needs have been newly added not only for the vehicle interior but also for power electronic (PE) components such as a battery and a motor. In the case of an electrified vehicle such as an electric vehicle or a fuel cell vehicle, thermal management needs of a vehicle interior space, a battery, and a power electronic component are all different depending on the configuration, shape, and type of the electrified vehicle.

Therefore, it is required to provide a technique capable of independently responding to different thermal management needs and efficiently performing various types of thermal management in a collaborative manner, making it possible to maximally reduce power consumption. Here, provided is an integrated thermal management system configured to improve thermal efficiency by independently performing thermal management for each configuration and simultaneously integrating all of the thermal management configurations for a vehicle.

Accordingly, an electrified vehicle such as an electric vehicle or a fuel cell vehicle has an integrated thermal management system mounted therein and configured to perform overall thermal management for the vehicle. The vehicle thermal management system manages energy required for internal heating and cooling and energy required for cooling or heating of a battery and a power electric (PE) component.

The vehicle thermal management system may be a system broadly including a cooling system and a heating system (including a heat pump system) that perform indoor air conditioning and a component thermal management system using refrigerant and coolant to perform thermal management such as cooling or heating of a battery and a power electronic component.

Normally, in the vehicle thermal management system, a cooling and heating system includes a refrigerant system in which a compressor, a condenser, a receiver dryer, an expansion valve, an evaporator, and an accumulator are connected to each other through a refrigerant line.

The above-described components of the refrigerant system are main components of an air-conditioning system for vehicle interior cooling, and refrigerant sequentially passes through the components while circulating along the refrigerant line.

Furthermore, the vehicle thermal management system includes a water pump configured to circulate refrigerant and coolant, a chiller configured to perform heat-exchange between refrigerant and coolant, and a coolant system including a radiator connected thereto through a coolant line and configured to perform heat-exchange between coolant and air. The coolant system is widely used in a component thermal management system configured to perform thermal management such as cooling or heating of a battery and a power electronic component.

Furthermore, the vehicle thermal management system may be operated in a plurality of modes including a heating mode in which heated air is supplied to the vehicle interior for vehicle interior heating, an internal cooling mode in which cooled air is supplied to the vehicle interior for vehicle interior cooling (air-conditioning mode), and a dehumidification mode in which air that has exchanged heat with refrigerant is supplied to the vehicle interior for vehicle interior dehumidification.

Among the above-described modes, refrigerant and an electric heater (for example, a PTC heater) may be used when the heating mode is operated. Furthermore, when the refrigerant temperature is sufficiently high, internal heating may be performed using an internal condenser (an indoor heat-exchanger) through which high-temperature refrigerant passes without using an electric heater.

Meanwhile, research and development has been actively conducted to increase efficiency of a heat pump in an electric vehicle. One of the methods of increasing efficiency of the heat pump is to use a gas injection type heat pump.

The gas injection type heat pump adopts a method of using a heat-exchanger or a flash tank to increase a flow rate of refrigerant circulating during heating, increasing heating efficiency of the vehicle.

In the case of conventional gas injection heat pump systems, there is a limitation in that most of the systems are used only to secure the flow rate of gaseous refrigerant during heating. In other words, in the conventional gas injection heat pump systems, after primary expansion, gaseous refrigerant itself is drawn into a compressor without a heat source, so that the flow rate of refrigerant is secured. However, there is a disadvantage in that it is difficult to secure a sufficient heating heat source.

Therefore, research and development needs to be conducted on a new technique capable of employing the gas injection heat pump system configured to perform air conditioning for heating and cooling. Furthermore, it is required to develop a system capable of performing additional heat dissipation in response to an increase in heat load due to rapid battery charging of an electric vehicle and application of a two-pass condenser, and a system capable of eliminating a single component such as an electric heater (for example, a PTC heater) and reducing the number of parts to reduce vehicle manufacturing costs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle thermal management system configured for not only solving a problem related to high temperature and high pressure in the system by additionally discharging heat of refrigerant to the outside in a refrigerant system in which the refrigerant circulates, but also improving internal cooling performance, battery cooling performance, and the like by stabilizing the system.

The objects of the present disclosure are not limited to the above-mentioned objects, and other technical objects not mentioned herein will be clearly understood by those skilled in the art to which the present disclosure pertains (referred to hereinafter as “those skilled in the art”) from the DETAILED DESCRIPTION.

In one aspect, the present disclosure provides a vehicle thermal management system including a refrigerant system including an external condenser and a first expansion valve connected by a refrigerant line and configured to cause, while refrigerant circulates along a refrigerant line, the refrigerant to sequentially pass through an external condenser and a first expansion valve, a component thermal management system including a battery or a power electric (PE) component connected by a coolant line and configured to perform, using the refrigerant distributed from the refrigerant system and coolant circulating along a coolant line, thermal management of a battery or a power electric (PE) component, and a heat-exchanger including a heat-exchange portion connected to the coolant line and provided to allow the coolant circulating through the component thermal management system to pass through the heat-exchange portion, wherein the heat-exchanger is provided on the refrigerant line between the external condenser and the first expansion valve and performs heat-exchange between the coolant passing through the heat-exchange portion and the refrigerant injected from the refrigerant line.

In an exemplary embodiment of the present disclosure, the component thermal management system may include a PE thermal management system configured to perform the thermal management on the PE component, wherein the PE thermal management system may include a first water pump configured to circulate PE coolant, a water heater configured to heat the PE coolant, a PE coolant passage portion provided in the PE component and configured to allow the PE coolant to pass through the PE coolant passage portion, a radiator configured to perform heat-exchange between the PE coolant and air, and a PE coolant line connecting the first water pump, the water heater, the PE coolant passage portion, and the radiator to each other, wherein the PE coolant circulates along the PE coolant line.

In another exemplary embodiment of the present disclosure, the component thermal management system may further include a chiller refrigerant line connected to the refrigerant line of the refrigerant system to allow the refrigerant of the refrigerant system to be distributed thereto and flow therethrough, a chiller including the PE coolant line connected thereto and the chiller refrigerant line connected thereto, wherein the chiller performs heat-exchange between the PE coolant and the refrigerant, and a third expansion valve provided on the chiller refrigerant line in a refrigerant inlet side of the chiller.

In yet another exemplary embodiment of the present disclosure, the component thermal management system may further include a battery thermal management system configured to perform the thermal management on the battery, wherein the battery thermal management system may include a second water pump configured to circulate battery coolant, a battery coolant passage portion provided in the battery and configured to allow the battery coolant to pass therethrough, and a battery coolant line connecting the second water pump to the battery coolant passage, wherein the battery coolant circulates along the battery coolant line.

In yet another exemplary embodiment of the present disclosure, the battery coolant line may be connected to the chiller, and the chiller may be provided to perform, while allowing two or three of the refrigerant of the chiller coolant line, the PE coolant of the PE coolant line, and the battery coolant of the battery coolant line to pass therethrough, the heat-exchange between the two or three thereof.

In still yet another exemplary embodiment of the present disclosure, the component thermal management system may further include a refrigerant bypass line branching from the chiller refrigerant line on an inlet side of the chiller and connected to the chiller refrigerant line on an outlet side the chiller, and the third expansion valve formed as a three-way valve and configured to expand the refrigerant may be provided at a location allowing the refrigerant bypass line to branch from the chiller refrigerant line on the inlet side of the chiller, allowing the refrigerant discharged from the third expansion valve to selectively flow through the chiller and the refrigerant bypass line.

In a further exemplary embodiment of the present disclosure, the outlet side of the chiller may be connected to an accumulator of the refrigerant system through the refrigerant line, allowing the refrigerant passing through the chiller to flow into the accumulator.

In another further exemplary embodiment of the present disclosure, the chiller refrigerant line may branch from the refrigerant line between a refrigerant outlet configured to allow the refrigerant in the heat-exchanger to be discharged therethrough and the first expansion valve, allowing the refrigerant discharged from the heat-exchanger to be distributed to the chiller refrigerant line and to flow therethrough.

In yet another further exemplary embodiment of the present disclosure, the heat-exchanger may include a coolant inlet configured to allow the coolant to flow into the heat-exchange portion therethrough, and a coolant outlet configured to allow the coolant passing through the heat-exchange portion to be discharged therethrough, the coolant inlet may be connected to the coolant line on an outlet side of the radiator, and the coolant outlet may be connected to the coolant line on an inlet side of the water heater and an inlet side of the PE coolant passage portion.

In yet another further exemplary embodiment of the present disclosure, the heat-exchanger may include a coolant inlet configured to allow the coolant to flow into the heat-exchange portion therethrough, and a coolant outlet configured to allow the coolant passing through the heat-exchange portion to be discharged therethrough, and the PE management system may further include a first coolant bypass line connecting the coolant line on an outlet side of the first water pump to the coolant line connected to the coolant inlet of the heat-exchanger, and a first valve provided at a location allowing the first coolant bypass line to be connected to the coolant line on an inlet side of the radiator and configured to control a flow of the coolant.

In still yet another further exemplary embodiment of the present disclosure, the PE thermal management system may further include a second coolant bypass line connecting the coolant line on an inlet side of the first water pump to the coolant line connected to the coolant outlet of the heat-exchanger, a connection line connecting the first coolant bypass line to the second coolant bypass line, and a second valve provided on the connection line and configured to control the flow of the coolant so that the coolant selectively flows through the connection line.

In a still further exemplary embodiment of the present disclosure, the second valve may be a three-way valve provided at a location allowing the connection line to be connected to the second coolant bypass line.

In a yet still further exemplary embodiment of the present disclosure, the PE thermal management system may further include a three-way valve configured to control a flow of the coolant between the coolant line on an outlet side of the PE coolant passage portion, the coolant line on an outlet side of the chiller, and the coolant line on an inlet side of the first water pump.

In a yet exemplary embodiment of the present disclosure, the heat-exchanger may include the heat-exchange portion provided therein, the heat-exchanger may include a refrigerant inlet configured to allow the refrigerant to flow into the heat-exchanger therethrough, and a first refrigerant outlet and a second refrigerant outlet each configured to allow the refrigerant present in the heat-exchanger to be discharged therethrough, and the refrigerant inlet may be connected to the refrigerant line on an outlet side of the external condenser.

In a yet further exemplary embodiment of the present disclosure, the first refrigerant outlet may be connected to the refrigerant line on an inlet side of a compressor configured to compress and discharge the refrigerant from the refrigerant system, and the second refrigerant outlet may be connected to the refrigerant line on an inlet side of the first expansion valve.

In yet another further exemplary embodiment of the present disclosure, the first refrigerant outlet may be provided at an upper portion of the heat-exchanger to discharge, from an inside of the heat-exchanger, gaseous refrigerant separated through gas-liquid separation, the second refrigerant outlet may be provided at a lower portion of the heat-exchanger to discharge liquid refrigerant, and the first refrigerant outlet may include an outlet valve provided on an outlet side thereof, wherein the outlet valve may maintain an opened state thereof to allow the refrigerant to be drawn into the compressor from the inside of the heat-exchanger through the first refrigerant outlet.

In still yet another further exemplary embodiment of the present disclosure, the heat-exchanger may be a flash tank including a refrigerant inlet and a refrigerant outlet, and the heat-exchange portion may be disposed on a lower side inside the flash tank.

In a still further exemplary embodiment of the present disclosure, the vehicle thermal management system may further include a refrigerant bypass line connecting the refrigerant line on an inlet side of the external condenser to the refrigerant line on an outlet side of the external condenser, wherein a second expansion valve formed as a three-way valve and configured to selectively expand the refrigerant may be provided at a location allowing the refrigerant line on the inlet side of the external condenser to be connected to the refrigerant bypass line.

Other aspects and exemplary embodiments of the present disclosure are discussed infra.

It is understood that the terms “vehicle”, “vehicular”, and other similar terms as used herein are inclusive of motor vehicles in general, such as passenger vehicles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing a circuit configuration of a vehicle thermal management system including a thermal management device according to an exemplary embodiment of the present disclosure.

FIG. 2 is a block diagram showing a control element and an operation element in the thermal management system according to the exemplary embodiment of the present disclosure.

FIG. 3 is a diagram showing a first internal cooling and battery cooling mode of the thermal management system according to the exemplary embodiment of the present disclosure.

FIG. 4 is a p-h diagram of refrigerant showing a state in which subcooling is secured, and high pressure of refrigerant of the system is relieved in the first internal cooling and battery cooling mode shown in FIG. 3.

FIG. 5 is a diagram showing a second internal cooling and battery cooling mode of the thermal management system according to the exemplary embodiment of the present disclosure.

FIG. 6 is a diagram showing an internal cooling mode, a battery cooling mode, and a PE cooling mode of the thermal management system according to the exemplary embodiment of the present disclosure.

FIG. 7 is a diagram showing a first heating and dehumidification mode of the thermal management system according to the exemplary embodiment of the present disclosure.

FIG. 8 is a p-h diagram showing that distributed heat absorption is performed through two-stage expansion of refrigerant in the first heating and dehumidification mode shown in FIG. 7.

FIG. 9 is a diagram showing a second heating and dehumidification mode of the thermal management system according to the exemplary embodiment of the present disclosure.

FIG. 10 is a p-h diagram showing that distributed heat absorption is performed through two-stage expansion of refrigerant in the second heating and dehumidification mode shown in FIG. 9.

FIG. 11 is a diagram showing a third heating and dehumidification mode of the thermal management system according to the exemplary embodiment of the present disclosure.

FIG. 12 is a p-h diagram showing a state in which distributed heat absorption is performed through two-stage expansion of refrigerant in the third heating and dehumidification mode shown in FIG. 11.

FIG. 13 is a diagram showing a heat pump heating mode of the thermal management system according to the exemplary embodiment of the present disclosure.

FIG. 14 is a p-h diagram showing that one-stage expansion of refrigerant and battery heat absorption are performed in the heat pump heating mode shown in FIG. 13.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Hereinafter, various exemplary embodiments of the present disclosure will be described in detail with reference to the appended drawings. Predetermined structural or functional descriptions provided in connection with the exemplary embodiments of the present disclosure are merely illustrative for describing embodiments according to the concept of the present disclosure, and the exemplary embodiments according to the concept of the present disclosure may be implemented in various forms. Furthermore, it will be understood that the present description is not intended to limit the present disclosure to the embodiments. On the other hand, the present disclosure is directed to cover not only the embodiments, but also various alternatives, modifications, equivalents, and other embodiments, which may be included within the spirit and scope of the present disclosure as defined by the appended claims.

Meanwhile, in an exemplary embodiment of the present disclosure, terms such as “first” and/or “second” may be used to describe various components, but the components are not limited by the terms. The terms are used only for distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

The same reference numerals represent the same components throughout the specification. Additionally, the terms in the specification are used merely to describe embodiments and are not intended to limit the present disclosure. In the present specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

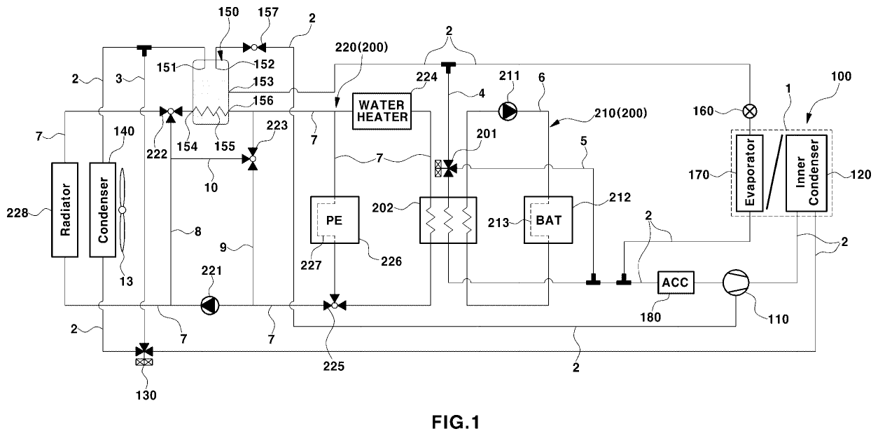

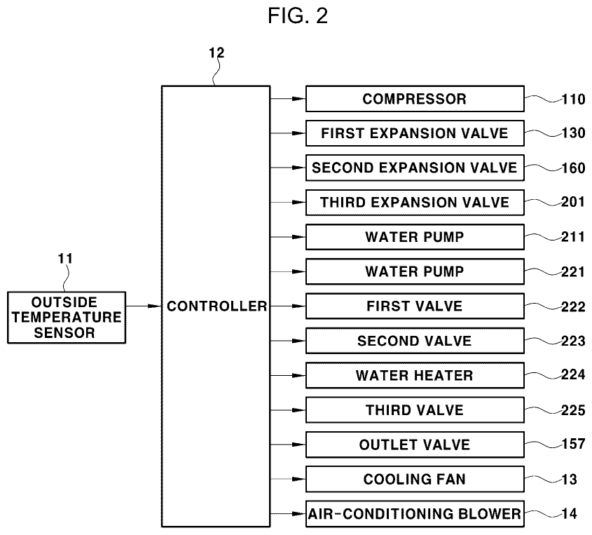

FIG. 1 is a diagram showing a circuit configuration of a vehicle thermal management system including a thermal management device according to an exemplary embodiment of the present disclosure, and FIG. 2 is a block diagram showing a control element and an operation element in the thermal management system according to the exemplary embodiment of the present disclosure.

In the thermal management system of the present disclosure, instead of eliminating a conventional water-cooled heat-exchanger (a water-cooled condenser), water-cooled condensing may be implemented using a flash tank 150 and a radiator 228 of a gas injection heat pump. Through the present structural configuration, it is possible not only to secure a subcooled area in which heat from refrigerant is additionally discharged, but also to solve a high pressure problem of the refrigerant in the system. Here, the flash tank 150 is a heat-exchanger configured to perform heat-exchange between refrigerant and coolant.

Additionally, in the thermal management system of the present disclosure, it is possible to remove a single component such as an existing electric heater (for example, a PTC heater) by securing an additional heat source and improving heating performance, making it possible not only to reduce the number of parts, but also to reduce vehicle manufacturing costs.

Furthermore, the thermal management system of the present disclosure includes a heat pump boosting thermal management circuit using a water heater 224. Generally, a water heater is provided on a coolant line along which battery coolant circulates. That is, the water heater is provided in a battery thermal management circuit adapted to cool or heat a battery. As a result, the water heater is used only to heat the battery.

However, in an exemplary embodiment of the present disclosure, the water heater 224 may be used not only for battery heating, but also for heat pump boosting and heating of a power electric (PE) component 226. In other words, it is possible to expand a range of application of the water heater beyond usability limitations of the water heater 224, and to utilize the water heater 224 for various purposes, achieving versatility of the water heater.

In the present manner, the water heater 224 may be used for heat pump boosting, removing the electric heater (for example, the PTC heater). Furthermore, various modes may be implemented by use of the heat pump boosting thermal management circuit in an exemplary embodiment of the present disclosure.

As shown in the drawings, the vehicle thermal management system according to the exemplary embodiment of the present disclosure includes a cooling and heating system 100 configured to perform cooling and heating for the vehicle interior using refrigerant, and a component thermal management system 200 configured to perform, using coolant and refrigerant, thermal management such as cooling and heating of a battery 212 or the power electronic (PE) component 226.

The heating and cooling system 100 includes a compressor 110, an internal condenser 120, a second expansion valve 130, an external condenser 140, a first expansion valve 160, an evaporator 170, and an accumulator 180, which are components of a refrigerant system. The main components of the heating and cooling system 100 are connected to each other through a refrigerant line 2 so that refrigerant may sequentially pass through and circulate around the main components.

Among the above-described components, the compressor 110, the external condenser 140, the first expansion valve 160, and the evaporator 170 are main components of an air-conditioning system for vehicle interior cooling. In the internal cooling mode, refrigerant compressed by the compressor 110 is condensed in the external condenser 140 and then is expanded in the first expansion valve 160. Thereafter, the low-temperature refrigerant expanded in the first expansion valve 160 cools air-to-be-conditioned while passing through the evaporator 170.

In the components of the cooling and heating system 100, the compressor 110 compresses refrigerant drawn from the accumulator 180 at high temperature and high pressure and transfers the compressed refrigerant through the refrigerant line 2, enabling the refrigerant to circulate along the refrigerant line 2. Furthermore, the internal condenser 120 is a heat-exchanger configured to perform heat-exchange between the refrigerant and the air-to-be-conditioned and is a component configured to heat the vehicle interior.

The high-temperature and high-pressure refrigerant discharged from the compressor 110 is supplied to the internal condenser 120 through the refrigerant line 2. Accordingly, the high-temperature and high-pressure refrigerant supplied to the internal condenser 120 performs, while passing through the interior of the internal condenser 120, heat-exchange with air-to-be-conditioned passing through the periphery of the internal condenser 120.

The internal condenser 120 and the evaporator 170 are provided in an air-conditioning case 1. Air-to-be-conditioned blown by an air-conditioning blower 14 is configured to pass through the periphery of the internal condenser 120 while moving along the interior of the air-conditioning case 1. In the instant case, the air-to-be-conditioned is heated by the high-temperature refrigerant passing through the interior of the internal condenser 120 and then is discharged into the vehicle interior, heating the vehicle interior.

The refrigerant that has exchanged heat with the air-to-be-conditioned in the internal condenser 120 is supplied to the second expansion valve 130 through the refrigerant line 2. Here, the refrigerant may be expanded to a low-temperature and low-pressure state while passing through the second expansion valve 130. The second expansion valve 130 controlled by a controller 12 may be an electronic expansion valve configured for selectively expanding the refrigerant.

In the exemplary embodiment of the present disclosure, a separate refrigerant line 3 (hereinafter referred to as a “first refrigerant bypass line”) branches from a refrigerant line 2 on the outlet side of the internal condenser 120 and a refrigerant line on the inlet side of the external condenser 140, that is, the refrigerant line 2 between the internal condenser 120 and the external condenser 140.

The first refrigerant bypass line 3 is a refrigerant line on the outlet side of the external condenser 140 and is connected to a refrigerant line on the inlet side of the flash tank 150 to be described later, that is, the refrigerant line 2 between the external condenser 140 and the flash tank 150.

As shown in FIG. 1, the first refrigerant bypass line 3 branches from the refrigerant line 2 on the inlet side of the external condenser 140 via the second expansion valve 130 and is connected to the refrigerant line 2 on the outlet side of the external condenser 140. Here, the second expansion valve 130 may be an electronic three-way expansion valve, the opening state of which is controlled by the controller 12.

In the three-way type second expansion valve 130, refrigerant may be discharged to the refrigerant line 2 and supplied to the external condenser 140 configured to perform heat-exchange between the refrigerant and air, or may be discharged to the first refrigerant bypass line 3 and supplied to the flash tank 150.

The refrigerant supplied to the external condenser 140 performs, while passing through the interior of the external condenser 140, heat-exchange with air passing through the periphery of the external condenser 140. Here, the air is outside air drawn by a cooling fan 13, and the low-temperature and low-pressure refrigerant expanded in the second expansion valve 130 may receive, while passing through the interior of the external condenser 140, heat from the outside air passing through the periphery of the external condenser 140.

In the present manner, the second expansion valve 130 and the external condenser 140 may be used as components configured for implementing a heat pump operation in which heat is received from the outside air (outside air heat absorption) and is supplied and moved through the refrigerant of the refrigerant system.

Furthermore, the refrigerant that has passed through the internal condenser 120 may be moved along the refrigerant line 2 and then may be discharged from the second expansion valve 130 to the first refrigerant bypass line 3, enabling the refrigerant to pass through the first refrigerant bypass line 3. In the instant case, the refrigerant bypasses the external condenser 140 without passing therethrough.

In the present manner, the first refrigerant bypass line 3 is the refrigerant line 2 used to allow the refrigerant to bypass the external condenser 140. When the above-descried bypass operation is performed, the opening state of the second expansion valve 130 is controlled by the controller 12 so that the refrigerant is discharged through the first refrigerant bypass line 3 without passing through the refrigerant line 2 on which the external condenser 140 is provided.

In the exemplary embodiment of the present disclosure, when the internal condenser 120 connected to the refrigerant line 2 on the outlet side of the compressor 110 is an indoor heat-exchanger configured to perform heat-exchange between the refrigerant flowing through the inside of the air-conditioning case 1 and the air-to-be-conditioned, the external condenser 140 may be defined as an outdoor heat-exchanger configured to perform heat-exchange between the refrigerant flowing through the inside of the external condenser 140 and the outside air drawn by the cooling fan 13.

The external condenser 140 functions as a condenser (a radiator) configured to discharge heat from the refrigerant to the outside air in the internal cooling mode. Furthermore, the external condenser 140 may function as an evaporator configured to receive heat from the outside air through the refrigerant in the heating mode.

In the exemplary embodiment of the present disclosure, the refrigerant passing through the external condenser 140 is supplied to the flash tank 150 of the gas injection heat pump. Here, the flash tank 150 is connected to the outlet (refrigerant outlet) side of the external condenser 140 through the refrigerant line 2. Accordingly, the flash tank 150 receives the refrigerant that has passed through the external condenser 140.

That is, a refrigerant inlet 151 of the flash tank 150 is connected to the outlet side of the external condenser through the refrigerant line 2. Furthermore, the refrigerant passing through the first refrigerant bypass line 3 may be supplied to the flash tank 150 through the refrigerant inlet 151.

Gas-liquid separation is performed for the refrigerant injected into the flash tank 150. The flash tank 150 includes a first refrigerant outlet 152 through which gaseous refrigerant is discharged, and a second refrigerant outlet 153 through which liquid refrigerant is discharged.

The first refrigerant outlet 152 may be provided at the upper portion of the flash tank 150, and the second refrigerant outlet 153 may be provided at the lower portion of the flash tank 150. Here, the first refrigerant outlet 152 is connected to the inlet side of the compressor 110 through the refrigerant line 2, and the second refrigerant outlet 153 is connected to the inlet side of the first expansion valve 160 through the refrigerant line 2.

Accordingly, the gaseous refrigerant separated through gas-liquid separation may be drawn into the compressor 110 through the first refrigerant outlet 152 and the refrigerant line 2, and the liquid refrigerant may flow to the first expansion valve 160 through the second refrigerant outlet 153 and the refrigerant line 2.

Additionally, an outlet valve 157 is provided on the refrigerant line 2 connected to the first refrigerant outlet 152 of the flash tank 150, that is, the refrigerant line 2 connecting the first refrigerant outlet 152 of the flash tank 150 to the inlet of the compressor 110.

Furthermore, the flash tank 150 includes a coolant inlet 154 and a coolant outlet 156 provided at the lower portion thereof. The flash tank 150 includes a heat-exchange portion 155 provided on the lower side of an inside thereof and configured to allow coolant (PE coolant to be described) introduced through the coolant inlet 154 to pass through the inside of the flash tank 150 and then to be discharged through the coolant outlet 156.

The coolant introduced through the coolant inlet 154 in the flash tank 150 passes through the heat-exchange portion 155 and is discharged to a coolant line 7 (a PE coolant line) through the coolant outlet 156. While the coolant passes through the heat-exchange portion 155, heat-exchange is performed between the coolant and the refrigerant inside the flash tank 150.

The outlet valve 157 is a valve configured to open or close the refrigerant line 2 to allow the refrigerant to selectively flow through the refrigerant line 2 between the flash tank 150 and the compressor 110. Here, opening and closing operations of the outlet valve 157 are controlled by the controller 12.

When the outlet valve 157 is closed by the controller 12, the refrigerant in the flash tank 150 may not be drawn into the compressor 110 through the first refrigerant outlet 152. When the outlet valve 157 is opened by the controller 12, the refrigerant in the flash tank 150 may be discharged through the first refrigerant outlet 152 and may be drawn into the compressor 110 through the refrigerant line 2.

The first expansion valve 160 receives the refrigerant discharged from the flash tank 150, expands the same to a low-temperature and low-pressure state, and allows the expanded refrigerant to be supplied to the evaporator 170 through the refrigerant line 2. The first expansion valve 160 may be a mechanical expansion valve, or an electronic expansion valve configured for selectively expanding the refrigerant. Here, the controller 12 is configured to control the operation of the electronic expansion valve.

When the low-temperature and low-pressure refrigerant expanded by the first expansion valve 160 is supplied to the evaporator 170 provided in the air-conditioning case 1, heat-exchange may be performed between the low-temperature and low-pressure refrigerant passing through the inside of the evaporator 170 and air-to-be-conditioned passing through the periphery of the evaporator 170.

In the present manner, the air-to-be-conditioned blown into the inside of the air-conditioning case 1 by the air-conditioning blower 14 may be cooled by the refrigerant passing through the inside of the evaporator 170 while passing through the periphery of the evaporator 170. In the instant case, conditioned air cooled by the refrigerant is discharged into the vehicle interior, cooling the vehicle interior.

The outlet of the evaporator 170 is connected to the inlet of the accumulator 180 through the refrigerant line 2, and the outlet of the accumulator 180 is connected to the inlet of the compressor 110 through the refrigerant line 2. In the instant case, the inlet through which the refrigerant flows and the outlet through which the refrigerant is discharged may be provided at an upper portion of the accumulator 180.

Accordingly, the refrigerant passing through the evaporator 170 is moved to the accumulator 180, and gas-liquid separation of the refrigerant is performed in the accumulator 180. The accumulator 180 is configured to improve efficiency and durability of the compressor 110 by supplying only gaseous refrigerant to the compressor 110 through gas-liquid separation.

As a result, the refrigerant of the cooling and heating system 100 may sequentially pass through, while circulating along the refrigerant line 2, the compressor 110, the internal condenser 120, the second expansion valve 130, and the external condenser 140. Thereafter, the refrigerant may be moved and injected into the flash tank 150.

Accordingly, the refrigerant may be discharged from the flash tank 150 to the refrigerant line 2 through the first refrigerant outlet 152 and may pass through the outlet valve 157. Here, the refrigerant may be drawn again into the compressor 110. Thereafter, the refrigerant circulates again along the refrigerant line 2 by the compressor 110.

Alternatively, the refrigerant may be moved and injected into the compressor 110, the internal condenser 120, the second expansion valve 130, the first refrigerant bypass line 3, and the flash tank 150 depending on the opening state of the second expansion valve 130.

Accordingly, the refrigerant may be discharged from the flash tank 150 to the refrigerant line 2 through the first refrigerant outlet 152, may pass through the outlet valve 157, and may be drawn again into the compressor 110. Thereafter, the refrigerant circulates again along the refrigerant line 2 by the compressor 110.

Alternatively, the refrigerant that has moved to the flash tank 150 through the above-mentioned path may be discharged through the second refrigerant outlet 153. Subsequently, the refrigerant may be drawn into the compressor 110 after moving to the first expansion valve 160, the evaporator 170, and the accumulator 180. Thereafter, the refrigerant circulates again along the refrigerant line 2 by the compressor 110.

Meanwhile, a chiller refrigerant line 4 branches from the refrigerant line 2 connected to the second refrigerant outlet 153 of the flash tank 150, that is, the refrigerant line 2 between the flash tank 150 and the first expansion valve 160. Here, the chiller refrigerant line 4 is connected to the refrigerant line 2 on the inlet side of the accumulator 180.

A third expansion valve 201, which is an expansion valve for a chiller, and a chiller 202 are provided on the chiller refrigerant line 4, and a second refrigerant bypass line 5 branches from the chiller refrigerant line 4 via the third expansion valve 201.

The second refrigerant bypass line 5 is connected to and combined with the chiller refrigerant line 4 on the outlet side of the chiller 202 or the refrigerant line 2 on the inlet side of the accumulator 180. Accordingly, the refrigerant discharged from the third expansion valve 201 to the second refrigerant bypass line 5 to bypass the chiller 202 may flow to the accumulator 180. Subsequently, the refrigerant may be drawn by the compressor 110 in the accumulator 180. Thereafter, the refrigerant may circulate again along the refrigerant line 2.

The third expansion valve 201 may be an electronic three-way expansion valve, the opening state of which is controlled by the controller 12. The third expansion valve 201 may allow, depending on the opening state thereof, the refrigerant that has moved from the refrigerant line 2 to the chiller refrigerant line 4 to flow to the second refrigerant bypass line 5 or to flow to the chiller 202.

As described above, the third expansion valve 201 formed as a three-way valve and the second refrigerant bypass line 5 branching from the third expansion valve 201 are components configured for allowing the refrigerant to selectively bypass the chiller 202.

The chiller 202 is provided to allow a cooling medium to pass therethrough. Here, examples of the cooling medium include refrigerant that has passed through the third expansion valve 201, coolant (battery coolant) of a battery thermal management system 210, and coolant (PE coolant) of a power electric (PE) thermal management system 220. Accordingly, heat-exchange may be performed between the cooling mediums passing through the chiller 202.

The component thermal management system 200 includes the battery thermal management system 210 and the PE thermal management system 220 configured to circulate coolant, respectively. The battery thermal management system 210 is provided to control and manage the temperature of the battery 212 and includes a configuration in which a battery coolant line 6 connects a battery coolant passage portion 213 provided in the battery 212 to the chiller 202 to allow battery coolant to circulate therealong. Furthermore, in the battery thermal management system 210, a water pump 211 (second water pump) is provided on the battery coolant line 6.

Furthermore, the PE thermal management system 220 is configured to control and manage the temperature of the power electronic component 226 (hereinafter referred to as a “PE component”) and includes a configuration in which a PE coolant line 7 connects a PE coolant passage portion 227 provided in the PE portion 226 to the water heater 224, the chiller 202, and the radiator 228 to allow PE coolant to circulate therealong. In the PE thermal management system 220, a water pump 221 (a first water pump) is provided on the PE coolant line 7.

In the exemplary embodiment of the present disclosure, the PE component 226 may include an inverter and a motor mounted on an electric vehicle. The PE component 226 may include at least one of a front wheel motor and a rear wheel motor each provided as a driving device, a front-wheel inverter configured to drive and control the front wheel motor, and a rear wheel inverter configured to drive and control the rear-wheel motor.

Here, the front wheel motor is a motor connected to front wheels of the vehicle to transmit power thereto and configured to drive the front wheels, and the rear wheel motor is a motor connected to rear wheels of the vehicle to transmit power thereto and configured to drive the rear wheels.

Furthermore, in the PE thermal management system 220, a separate coolant line, that is, a first coolant bypass line 8 connects the PE coolant line 7 on the inlet side of the radiator 228 to the PE coolant line 7 on the outlet side of the radiator 228.

The first coolant bypass line 8 branches from the PE coolant line 7 disposed between the water pump 221 and the radiator 228 and is connected to the PE coolant line 7 between the radiator 228 and the flash tank 150.

Furthermore, a first valve 222 formed as a three-way valve is provided at a location allowing the first coolant bypass line 8 to be connected to and combined with the PE coolant line 7 between the radiator 228 and the flash tank 150.

In more detail, the PE coolant line 7 connected to the outlet of the radiator 228 is connected to the coolant inlet 154 of the heat-exchange portion 155 provided on the lower side in the flash tank 150.

In the instant case, the first valve 222 is provided in the middle portion of the PE coolant line 7 connecting the outlet of the radiator 228 to the coolant inlet 154 of the flash tank 150. The first coolant bypass line 8 is connected to and combined with the PE coolant line 7 between the outlet of the radiator 228 and the coolant inlet 154 of the flash tank 150 via the first valve 222.

Furthermore, the coolant outlet 156 of the flash tank 150, that is, the coolant outlet 156 of the heat-exchange portion 155 in the flash tank 150, is connected to the PE coolant line 7 between the PE coolant passage portion 227 and the water heater 224.

Here, a separate coolant line, that is, a second coolant bypass line 9 branches from the PE coolant line 7 connected to the coolant outlet 156 of the flash tank 150 to be connected to the PE coolant line 7 between a third valve 225 and the water pump 221.

Furthermore, a separate coolant line, that is, a connection line 10 connects the first coolant bypass line 8 to the second coolant bypass line 9, and a second valve 223 formed as a three-way valve is provided at a location allowing the connection line 10 to branch from the second coolant bypass line 9.

Furthermore, the PE coolant line 7 on the outlet side of the PE coolant passage portion 227, the PE coolant line 7 on the outlet side of the chiller 202, and the PE coolant line 7 on the inlet side of the water pump 221 are connected to each other to allow coolant to flow therethrough via the third valve 225, which is a three-way valve. The water pump 221 is provided in the middle portion of the PE coolant line 7 connecting the third valve 225 to the inlet of the radiator 228.

In an exemplary embodiment of the present disclosure, each of the first valve 222, the second valve 223, and the third valve 225 may be an electronic three-way valve, the opening state of which is controlled by the controller 12. Since the opening states of these valves are controlled by the controller 12, a flow of coolant and a circulation path thereof in the PE thermal management system 220 may be controlled.

The PE coolant circulating along the PE coolant line 7 passes through the water heater 224, and when the water heater 224 is operated to generate heat, the PE coolant passing therethrough may be heated.

As described above, the configuration of the vehicle thermal management system according to the exemplary embodiment of the present disclosure has been described. Hereinafter, main operation modes of the above-described thermal management system will be described.

In the following description, the operations of operating components such as the compressor 110, the second expansion valve 130, the first expansion valve 160, the third expansion valve 201, the water pumps 211 and 221, the first valve 222, the second valve 223, the water heater 224, the third valve 225, the outlet valve 157, the cooling fan 13, and the air-conditioning blower 14 are controlled by the controller 12.

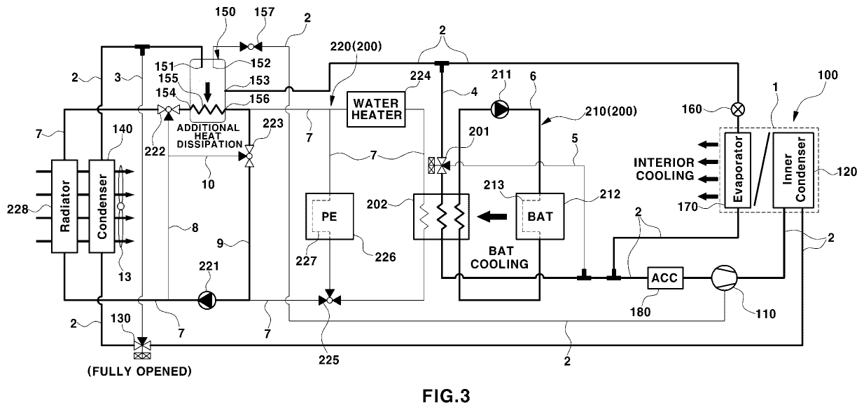

FIG. 3 is a diagram showing a first internal cooling and battery cooling mode of the thermal management system according to the exemplary embodiment of the present disclosure. FIG. 3 shows the circulation paths of refrigerant and coolant in a mode in which vehicle interior cooling and battery cooling are performed simultaneously.

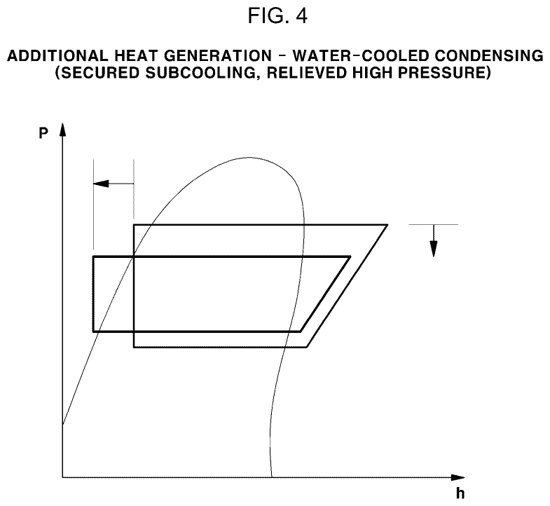

FIG. 4 is a p-h diagram of refrigerant showing a state in which subcooling is secured, and high pressure of refrigerant of the system is relieved in the first internal cooling and battery cooling mode shown in FIG. 3.

In the first internal cooling and battery cooling mode shown in FIG. 3, water-cooled condensing (additional heat dissipation) using the flash tank 150 and the radiator 228, outside air heat dissipation in the radiator 228 and the external condenser 140, and vehicle interior cooling are performed.

In the first internal cooling and battery cooling mode, according to the water-cooled condensing, in addition to refrigerant heat dissipation and condensation in the external condenser 140 provided as an air-cooled heat-exchanger, it is possible to additionally perform refrigerant heat dissipation and condensation in which heat from the refrigerant is discharged to the coolant by heat-exchange between the coolant and the refrigerant passing through the radiator 228 in the flash tank 150 of the gas injection system.

The refrigerant heat dissipation and condensation in the external condenser 140 are caused by heat-exchange between the refrigerant and the air (outside air). The refrigerant heat dissipation and condensation is the heat dissipation of the refrigerant to the air and the subsequent condensation of the refrigerant, which is performed when heat from the refrigerant passing through the inside of the external condenser 140 is discharged to the air passing through the periphery of the external condenser 140.

In an exemplary embodiment of the present disclosure, in addition to the air-cooled refrigerant heat dissipation and condensation in the external condenser 140 described above, water-cooled condensing (water-cooled refrigerant heat dissipation and condensation) using the radiator 228 and the flash tank 150 is additionally performed, maximally improving heat dissipation performance of the refrigerant.

Regarding the operation state, when the compressor 110 is driven by the controller 12, the high-temperature and high-pressure refrigerant discharged from the compressor 110 passes through the internal condenser 120, moves along the refrigerant line 2, and passes through the second expansion valve 130. Accordingly, after passing through the external condenser 140, the refrigerant is injected into the flash tank 150 through the refrigerant inlet 151 of the flash tank 150. In the instant case, the second expansion valve 130 is controlled to be in the fully opened state by the controller 12. In the present manner, the refrigerant may pass through the second expansion valve 130 without expansion thereof.

Furthermore, each of the water pumps 211 and 221 is operated by the controller 12 in the battery thermal management system 210 and the PE thermal management system 220 of the component thermal management system 200, allowing the coolant to circulate in each thermal management system.

Furthermore, the cooling fan 13 is operated by the controller 12, and outside air drawn by the cooling fan 13 sequentially passes through the periphery of the radiator 228 and the periphery of the external condenser 140.

In the instant case, since the PE coolant of the PE thermal management system 220 passes through the interior of the radiator 228, the radiator 228 performs heat-exchange in which heat from the PE coolant is discharged to the outside air (heat dissipation of the coolant to the outside air), cooling the PE coolant by the present heat-exchange.

Furthermore, the external condenser 140 performs heat-exchange in which heat from the refrigerant passing through the inside of the external condenser is discharged to the outside air passing through the periphery of the external condenser (heat dissipation of the refrigerant to the outside air). In the present manner, the refrigerant is cooled and condensed by the present heat-exchange.

In the first internal cooling and battery cooling mode, the PE coolant passing through the radiator 228 passes through the heat-exchange portion 155 in the flash tank 150 through the first valve 222. Accordingly, after moving from the PE coolant line 7 to the second coolant bypass line 9, the PE coolant circulates through the path of the second valve 223, the water pump 221, and the radiator 228.

Furthermore, in the first internal cooling and battery cooling mode, coolant is controlled to prevent the coolant from flowing to the chiller 202, the water heater 224, the PE coolant passage portion 227, and the PE coolant line 7 connected thereto.

In the present manner, the opening states of the first valve 222, the second valve 223, and the third valve 225 are controlled by the controller 12 to allow the PE coolant to circulate along the above-described path including the PE coolant line 7 and the second coolant bypass line 9.

That is, in the case of the first valve 222, the flow path of the first coolant bypass line 8 is blocked to prevent the coolant discharged from the radiator 228 from flowing to the first coolant bypass line 8, and the PE coolant line 7 on the outlet side of the radiator 228 and the PE coolant line 7 on the inlet side of the heat-exchange portion 155 in the flash tank 150 are controlled to communicate with each other.

Furthermore, in the case of the second valve 223, the flow path of the second coolant bypass line 9 is opened to allow the coolant to pass through the second coolant bypass line 9, and the connection line 10 is controlled to prevent the coolant from flowing therethrough.

Furthermore, the third valve 225 is controlled to block the flow paths of all of the connected PE coolant lines 7 such as the PE coolant line 7 connected to the PE coolant passage portion 227, the PE coolant line 7 connected to the chiller 202, and the PE coolant line 7 connected to the water pump 221.

As described above, while the PE coolant passes through the heat-exchange portion 155 in the flash tank 150, heat-exchange is performed between the refrigerant collected in the flash tank 150 and the PE coolant. At the instant time, heat from the refrigerant is transferred to the PE coolant, additionally performing heat dissipation and condensation of the refrigerant. That, water-cooled condensing (condensing of the refrigerant by coolant) using the radiator 228 and the flash tank 150 is performed.

Moreover, in the first internal cooling and battery cooling mode, the outlet valve 157 is controlled to be in the closed state by the controller 12. As a result, the refrigerant in the flash tank 150 is not discharged to the first refrigerant outlet 152.

In the instant case, the liquid refrigerant of the flash tank 150 is discharged to the refrigerant line 2 through the second refrigerant outlet 153. While the refrigerant discharged through the second refrigerant outlet 153 moves along the refrigerant line 2, a portion of the refrigerant is distributed to the chiller refrigerant line 4, and the remaining refrigerant moves to the first expansion valve 160.

The refrigerant distributed to the chiller refrigerant line 4 moves to the third expansion valve 201. Thereafter, the refrigerant is expanded to a low-temperature and low-pressure state while passing through the third expansion valve 201. Accordingly, the refrigerant exchanges, while passing through the chiller 202, heat with the battery coolant circulating along the battery coolant line 6.

The third expansion valve 201 is controlled by the controller 12 to block the flow path of the second refrigerant bypass line 5. Accordingly, the entire refrigerant may be supplied from the third expansion valve 201 to the chiller 202, and the refrigerant does not flow through the second refrigerant bypass line 5.

In the present manner, the battery coolant cooled by heat-exchange with the refrigerant while passing through the chiller 202 moves along the battery coolant line 6 and passes through the battery coolant passage portion 213. Accordingly, the battery coolant cools the battery 212 while passing through the battery coolant passage portion 213.

Additionally, the refrigerant that has been discharged from the flash tank 150 and has been moved to the first expansion valve 160 along the refrigerant line 2 is expanded to a low-temperature and low-pressure state while passing through the first expansion valve 160. Thereafter, the refrigerant passes through the evaporator 170 and then moves to the accumulator 180 along the refrigerant line 2.

Subsequently, gaseous refrigerant separated from liquid refrigerant in the accumulator 180 is drawn by the compressor 110. Thereafter, the gaseous refrigerant moves along the refrigerant line 2 and circulates again along the refrigerant circulation path of the refrigerant system.

While the refrigerant passes through the evaporator 170, air-to-be-conditioned blown by the air-conditioning blower 14 moves along the air-conditioning case 1 and passes through the periphery of the evaporator 170. Here, heat-exchange is performed between the low-temperature refrigerant passing through the inside of the evaporator 170 and the air-to-be-conditioned passing through the periphery of the evaporator 170. In the present manner, conditioned air cooled by heat-exchange with the refrigerant is discharged into the vehicle interior, cooling the vehicle interior.

The first internal cooling and battery cooling mode has been described above. In the first internal cooling and battery cooling mode, secondary refrigerant heat dissipation is performed in the flash tank 150 after primary refrigerant heat dissipation is performed in the external condenser 140, securing additional subcooling.

Additionally, in the first internal cooling and battery cooling mode, the refrigerant pressure of the system may be lowered and stabilized due to additional heat dissipation of the refrigerant. As a result, additional subcooling may be used for vehicle interior cooling and battery cooling, making it possible to improve cooling performance for the vehicle interior and battery cooling performance.

The pressure (p)-enthalpy (h) diagram in FIG. 4 shows a state in which pressure of the refrigerant in the system is lowered by heat dissipation and condensation of the refrigerant using the external condenser 140 and additional heat dissipation and condensation (water-cooled condensing) of the refrigerant using the radiator 228 and the flash tank 150 in the first internal cooling and battery cooling mode described above, solving a problem of high pressure of the conventional refrigerant and additionally securing a subcooled area.

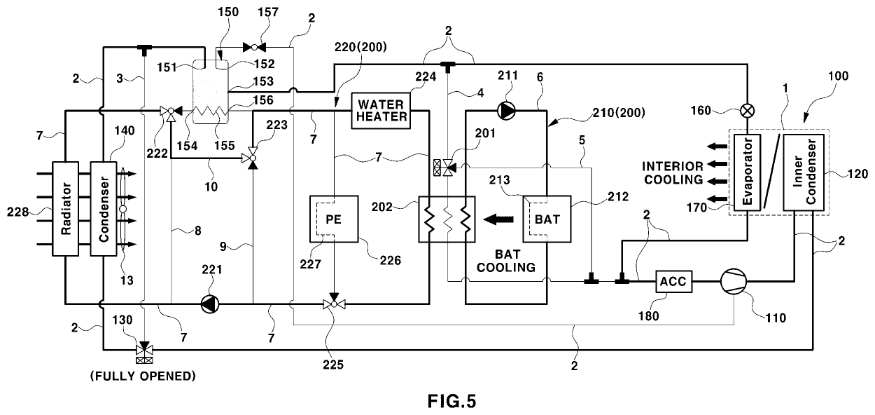

Next, FIG. 5 is a diagram showing a second internal cooling and battery cooling mode of the thermal management system according to the exemplary embodiment of the present disclosure. FIG. 5 shows the circulation paths of refrigerant and coolant in another mode in which vehicle interior cooling and battery cooling are performed simultaneously.

The second internal cooling and battery cooling mode may be performed when the outside temperature is sufficiently low. In the second internal cooling and battery cooling mode, coolant bypasses the flash tank 150 so as not to pass through the heat-exchange portion 155 of the flash tank 150. Accordingly, secondary refrigerant heat dissipation and condensation in the flash tank are not performed.

However, the PE coolant cooled by the outside air in the radiator 228 bypasses the flash tank 150 and then moves along the PE coolant line 7. Thereafter, the PE coolant is supplied to the chiller 202, and heat-exchange is performed between the PE coolant and the battery coolant in the chiller 202. As a result, the battery 212 is cooled while the battery coolant cooled by the PE coolant passes through the battery coolant passage portion 213.

Refrigerant circulation in the second internal cooling and battery cooling mode is not different from that in the first internal cooling and battery cooling mode except that the entire refrigerant discharged to the refrigerant line 2 through the second refrigerant outlet 153 of the flash tank 150 is supplied to the first expansion valve 160 without being distributed to the chiller refrigerant line 4.

A description will be provided as to an operation state in detail. First, the controller 12 may be set to enter the second internal cooling and battery cooling mode when the outside temperature detected by an outside temperature sensor (refer to “11” in FIG. 2) is lower than a predetermined set temperature.

When the second internal cooling and battery cooling mode are started, the compressor 110 is driven by the controller 12, and the high-temperature and high-pressure refrigerant discharged from the compressor 110 passes through the internal condenser 120 and then circulates along the refrigerant line 2.

The refrigerant passing through the internal condenser 120 passes through the second expansion valve 130 and passes through the external condenser 140. Thereafter, the refrigerant is injected into the flash tank 150 through the refrigerant inlet 151 of the flash tank 150. In the instant case, the second expansion valve 130 is controlled to be in the fully opened state by the controller 12. In the present manner, the refrigerant may pass through the second expansion valve 130 without expansion thereof.

Additionally, in the battery thermal management system 210 and the PE thermal management system 220 of the component thermal management system 200, each of the water pumps 211 and 221 is operated by the controller 12 so that the coolant circulates in each of the thermal management systems.

Furthermore, the cooling fan 13 is operated by the controller 12, and the outside air drawn by the cooling fan 13 sequentially passes through the periphery of the radiator 228 and the periphery of the external condenser 140.

In the instant case, since the PE coolant of the PE thermal management system 220 passes through the interior of the radiator 228, the radiator 228 performs heat-exchange in which heat from the PE coolant is discharged to the outside air (heat dissipation of the coolant to the outside air), cooling the PE coolant by the present heat-exchange.

Furthermore, the external condenser 140 performs heat-exchange in which heat from the refrigerant passing through the inside of the external condenser is discharged to the outside air passing through the periphery of the external condenser (heat dissipation of the refrigerant to the outside air). In the present manner, the refrigerant is cooled and condensed by the present heat-exchange.

Accordingly, the PE coolant that has passed through the radiator 228 bypasses the flash tank 150 without passing through the flash tank 150. To the present end, the opening states of the first valve 222, the second valve 223, and the third valve 225 are controlled by the controller 12.

That is, when the opening states of the first valve 222, the second valve 223, and the third valve 225 are controlled, the PE coolant from the radiator 228 sequentially passes through the first valve 222, the first coolant bypass line 8, the connection line 10, the second valve 223, and the second coolant bypass line 9. Accordingly, the PE coolant moves to the PE coolant line 7 on the outlet side of the flash tank 150 and flows through the path of the water heater 224, the chiller 202, the third valve 225, and the water pump 221.

Thereafter, the PE coolant is supplied to the radiator 228 by the water pump 221 and then circulates again along the same path. In the instant case, the coolant is prevented from flowing through the PE coolant passage portion 227 and the PE coolant line 7 connected to the inlet and outlet of the PE coolant passage portion. Furthermore, the water heater 224 maintains the OFF state thereof so as not to generate heat.

As described above, while the PE coolant circulates, heat-exchange is performed between the battery coolant and the PE coolant in the chiller 202. Here, the PE coolant in the chiller 202 receives heat from the battery coolant and then moves to the radiator 228 to discharge the heat.

Simultaneously, the battery coolant cooled by the PE coolant in the chiller 202 moves along the battery coolant line 6 and then passes through the battery coolant passage portion 213. Here, while passing through the battery coolant passage portion 213, the battery coolant cools the battery 212. Thereafter, the battery coolant circulates again along the battery coolant line 6 by the water pump 211.

In the second internal cooling and battery cooling mode, the refrigerant passes through the flash tank 150 and circulates along a predetermined path. Here, the refrigerant is not discharged to the first refrigerant outlet 152 in the flash tank 150. To the present end, the outlet valve 157 is controlled to be closed by the controller 12.

In the instant case, liquid refrigerant is discharged to the refrigerant line 2 through the second refrigerant outlet 153 of the flash tank 150 and then is supplied to the first expansion valve 160. Additionally, the controller 12 is configured to control the third expansion valve 201 provided on the chiller refrigerant line 4 to block all of the refrigerant flow paths. Accordingly, the refrigerant may not flow to the third expansion valve 201 and the chiller refrigerant line 4, and the entirety of the refrigerant moves to the first expansion valve 160.

The refrigerant that has moved to the first expansion valve 160 is expanded to a low-temperature and low-pressure state while passing through the first expansion valve 160. Thereafter, the refrigerant passes through the evaporator 170 and then moves to the accumulator 180 along the refrigerant line 2.

Accordingly, gaseous refrigerant separated from the liquid refrigerant inside the accumulator 180 is drawn by the compressor 110. Thereafter, the gaseous refrigerant moves again along the refrigerant line 2 and circulates again along the refrigerant circulation path of the refrigerant system.

Furthermore, while the refrigerant passes through the evaporator 170, air-to-be-conditioned blown by the air-conditioning blower 14 moves along the air-conditioning case 1 and passes through the periphery of the evaporator 170. Here, in the evaporator 170, heat-exchange is performed between the low-temperature refrigerant passing through the inside of the evaporator 170 and the air-to-be-conditioned passing through the periphery of the evaporator 170. In the present manner, conditioned air cooled by heat-exchange with the refrigerant is discharged into the vehicle interior, cooling the vehicle interior.

The second internal cooling and battery cooling mode have been described above. In the second internal cooling and battery cooling mode, the refrigerant condensed only by the external condenser 140 without using the flash tank 150 is used to cool the vehicle interior.

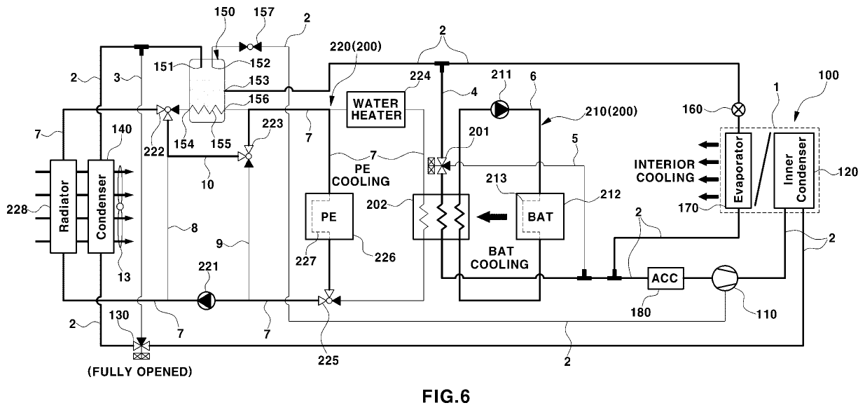

Next, FIG. 6 is a diagram showing an internal cooling mode, a battery cooling mode, and a PE cooling mode of the thermal management system according to the exemplary embodiment of the present disclosure. FIG. 6 shows the circulation paths of refrigerant and coolant in a mode in which cooling of the battery 212 and cooling of the PE component 226 are performed simultaneously along with cooling of the vehicle interior.

As shown in the drawing, in the internal cooling mode, the battery cooling mode, and the PE cooling mode, the refrigerant circulates along the same path as in the first internal cooling and battery cooling mode shown in FIG. 4. That is, the compressor 110 is driven by the controller 12, the second expansion valve 130 is controlled to be in the fully opened state, and the first expansion valve 160 and the third expansion valve 201 are controlled to expand the refrigerant. Furthermore, the outlet valve 157 is controlled to be in the closed state.

Furthermore, the third expansion valve 201 is controlled by the controller 12 to block the flow path of the second refrigerant bypass line 5. Accordingly, the entirety of the refrigerant may be supplied from the third expansion valve 201 to the chiller 202, and the refrigerant does not flow through the second refrigerant bypass line 5.

Additionally, in the case of PE coolant, compared to the second internal cooling and battery cooling mode shown in FIG. 5, there is a difference in that the PE coolant that has bypassed the flash tank 150 circulates through the PE coolant passage portion 227 without circulating through the water heater 224 and the chiller 202.

Except for the present difference, the circulation path of the remaining PE coolant is the same as that of the second internal cooling and battery cooling mode shown in FIG. 5. Furthermore, the circulation path of the battery coolant is also no different from that of the second internal cooling and battery cooling mode.

Furthermore, regarding the circulation path of the battery coolant, there is no difference in all of the first internal cooling and battery cooling mode (refer to FIG. 3), the second internal cooling and battery cooling mode (refer to FIG. 5), and the internal cooling mode, the battery cooling mode, and the PE cooling mode of the thermal management system (refer to FIG. 6). Furthermore, in the operation modes to be described below as well, there is no difference in the circulation path of the battery coolant.

In the internal cooling mode, the battery cooling mode, and the PE cooling mode shown in FIG. 6, the PE coolant circulates along the path of the water pump 221, the PE coolant line 7, the radiator 228, the PE coolant line 7, the first valve 222 configured to bypass the flash tank 150, the first coolant bypass line 8, the connection line 10, the second valve 223, the second coolant bypass line 9, and the PE coolant line 7, and the path of the PE coolant passage portion 227, the third valve 225, the PE coolant line 7, and the water pump 221.

Here, the third valve 225 is controlled to allow the PE coolant line 7 connected to the PE coolant passage portion 227 and the PE coolant line 7 on the inlet side of the water pump 221 to communicate with each other, and to block the PE coolant line 7 on the outlet side of the chiller 202.

Accordingly, the entire amount of PE coolant passing through the PE coolant passage portion 227 may flow only to the water pump 221, and the PE coolant does not pass through the water heater 224 and the chiller 202. In the instant case, the water heater 224 maintains the OFF state thereof so as not to generate heat.

As a result, while the PE coolant circulates along the above-described path, the PE coolant discharges heat from the radiator 228 to the outside air. Thereafter, the PE coolant bypasses the flash tank 150 and cools the PE component 226 while passing through the PE coolant passage portion 227.

Simultaneously, in the battery thermal management system 210, the battery coolant circulates along the battery coolant line 6 between the battery 212 and the chiller 202 by operation of the water pump 211. While circulating along the battery coolant line 6, the battery coolant is cooled by the refrigerant in the chiller 202. Furthermore, while the refrigerant cooled in the chiller 202 passes through the battery coolant passage portion 213, the battery 212 is cooled by the refrigerant.

In the internal cooling mode, the battery cooling mode, and the PE cooling mode shown in FIG. 6, the circulation path of the refrigerant is the same as that of the first internal cooling and battery cooling mode shown in FIG. 3, and a process of cooling the vehicle interior by refrigerant circulation is also the same as that of the first internal cooling and battery cooling mode. Therefore, a description as to an internal cooling process in the internal cooling mode, the battery cooling mode, and the PE cooling mode shown in FIG. 6 will be omitted.

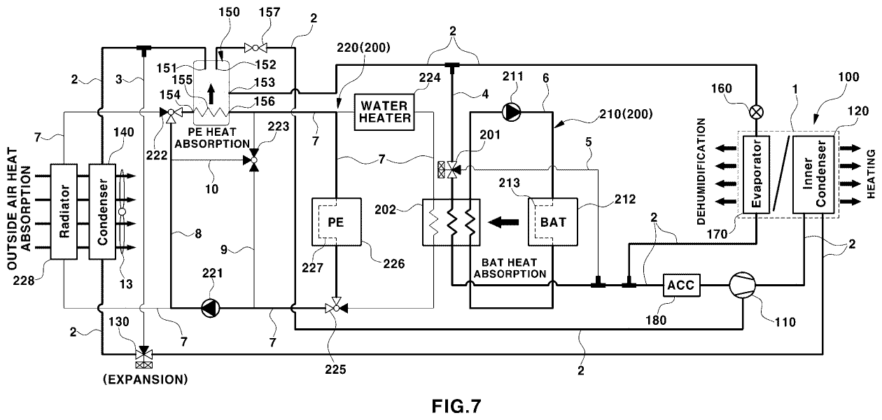

Next, FIG. 7 is a diagram showing a first heating and dehumidification mode of the thermal management system according to the exemplary embodiment of the present disclosure. FIG. 7 shows the circulation paths of refrigerant and coolant in a mode in which dehumidification is performed simultaneously with heating of the vehicle interior.

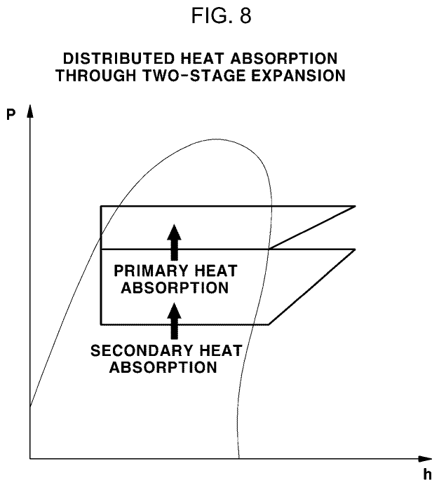

FIG. 8 is a p-h diagram showing that distributed heat absorption is performed through two-stage expansion of refrigerant in the first heating and dehumidification mode shown in FIG. 7.

In the first heating and dehumidification mode shown in FIG. 7, the vehicle interior is heated by operation of the heat pump, particularly operation of the gas injection heat pump using the flash tank 150.

The first heating and dehumidification mode is performed to maximally improve heat pump heating performance by controlling the vehicle thermal management system to perform outside air heat absorption, battery heat absorption (“BAT heat absorption”) and PE heat absorption during operation of the heat pump in winter.

Here, the outside air heat absorption means heat absorption (heat absorption of the refrigerant from the outside air) in which the refrigerant absorbs heat from the outside air in the external condenser 140, the battery heat absorption means heat absorption in which the refrigerant absorbs heat from the battery 212 through the battery coolant in the chiller 202, and the PE heat absorption means heat absorption (heat absorption of the refrigerant from the PE coolant) in which the refrigerant absorbs heat from the PE component 226 through the PE coolant in the chiller 2020.

Regarding the operation state, when the compressor 110 is driven by the controller 12, the high-temperature and high-pressure refrigerant discharged from the compressor 110 passes through the internal condenser 120. While the high-temperature refrigerant passes through the internal condenser 120, air-to-be-conditioned blown by the air-conditioning blower 14 moves along the air-conditioning case 1 and passes through the periphery of the internal condenser 120.

Accordingly, in the internal condenser 120, heat-exchange is performed between the high-temperature refrigerant passing through the inside of the internal condenser 120 and the air-to-be-conditioned passing through the periphery of the internal condenser 120. In the present manner, conditioned air heated by heat-exchange with the refrigerant is discharged into the vehicle interior, heating the vehicle interior.

The refrigerant passing through the internal condenser 120 moves along the refrigerant line 2 and passes through the second expansion valve 130. Accordingly, after passing through the external condenser 140, the refrigerant is injected into and collected in the flash tank 150 through the refrigerant inlet 151 of the flash tank 150.

Here, the second expansion valve 130 is controlled by the controller 12 to expand the refrigerant to a low-temperature and low-pressure state. Accordingly, the refrigerant is primarily expanded in the second expansion valve 130, and the low-temperature refrigerant that has been primarily expanded by the second expansion valve 130 passes through the inside of the external condenser 140.

In the instant case, outside air drawn by the cooling fan 13 passes through the periphery of the external condenser 140. Accordingly, the external condenser 140 performs heat-exchange in which the refrigerant (the primarily expanded refrigerant) passing through the inside of the external condenser 140 absorbs heat from the outside air passing through the periphery of the external condenser 140 (heat absorption of the refrigerant from the outside air, “outside air heat absorption”).

Furthermore, the refrigerant (the primarily expanded refrigerant) collected in the flash tank 150 after passing through the external condenser 140 exchanges heat with the PE coolant passing through the heat-exchange portion 155 in the flash tank 150. Here, the PE coolant is coolant that cools the PE component 226 and absorbs waste heat from the PE component 226 while passing through the PE coolant passage portion 227.

Therefore, the temperature of the PE coolant passing through the heat-exchange portion 155 is higher than that of the refrigerant inside the flash tank 150. Therefore, the heat-exchange portion 155 performs heat-exchange (“PE heat absorption”) in which the refrigerant absorbs heat from the PE coolant.

Accordingly, the refrigerant passes through the flash tank 150 and circulates along a predetermined path, and gaseous refrigerant in the flash tank 150 is discharged to the refrigerant line 2 through the first refrigerant outlet 152. In the instant case, the refrigerant discharged through the first refrigerant outlet 152 in a state in which the outlet valve 157 is opened by the controller 12 is drawn into the compressor 110 through the refrigerant line 2. Thereafter, the refrigerant circulates again along the refrigerant line 2 by the compressor 110.

Furthermore, liquid refrigerant is discharged to the refrigerant line 2 through the second refrigerant outlet 153 of the flash tank 150. While the refrigerant discharged through the second refrigerant outlet 153 moves along the refrigerant line 2, a portion of the refrigerant is distributed to the chiller refrigerant line 4, and the remaining refrigerant moves to the first expansion valve 160.

The refrigerant distributed to the chiller refrigerant line 4 is secondarily expanded to a low-temperature and low-pressure state while moving to the third expansion valve 201 and passing through the third expansion valve 201. Accordingly, the refrigerant passes through the chiller 202. In the chiller 202, heat-exchange is performed between the secondary expanded refrigerant and the battery coolant circulating along the battery coolant line 6.

Here, the third expansion valve 201 is controlled by the controller 12 to block the flow path of the second refrigerant bypass line 5. Accordingly, the entire amount of refrigerant may be supplied from the third expansion valve 201 to the chiller 202, and the refrigerant does not flow through the second refrigerant bypass line 5.

In the present manner, while passing through the chiller 202, the refrigerant absorbs heat generated from the battery 212 through heat-exchange with the battery coolant. Thereafter, the refrigerant that has absorbed waste heat from the battery 212 in the chiller 202 is discharged to the coolant line and is moved to the accumulator 180. Accordingly, the refrigerant is drawn by and transferred from the accumulator 180 through the compressor 110, circulating again along the refrigerant line 2.

Furthermore, the refrigerant discharged through the second refrigerant outlet 153 after completing the PE heat absorption in the flash tank 150, that is, the refrigerant discharged from the flash tank 150 after absorbing the heat from the PE coolant (waste heat from the PE component) through the heat-exchange portion 155 is expanded to a low-temperature and low-pressure state while passing through the first expansion valve 160. Thereafter, while the refrigerant passes through the inside of the evaporator 170, heat-exchange is performed between the refrigerant and air-to-be-conditioned blown by the air-conditioning blower 14.

Here, while passing through the inside of the evaporator 170, the low-temperature refrigerant cools the air-to-be-conditioned passing through the periphery of the evaporator 170, and conditioned air cooled by the evaporator 170 is discharged into the vehicle interior, controlling humidity of the vehicle interior (dehumidification).

Furthermore, during the first heating and dehumidification mode, each of the water pumps 211 and 221 is operated by the controller 12 in the battery thermal management system 210 and the PE thermal management system 220 of the component thermal management system 200, allowing the coolant to be circulated in each of the thermal management systems.

Furthermore, the cooling fan 13 is operated by the controller 12, and the outside air drawn by the cooling fan 13 sequentially passes through the periphery of the radiator 228 and the periphery of the external condenser 140.

At the present time, the opening state of the first valve 222 is controlled by the controller 12 to allow the entire amount of PE coolant discharged from the water pump 221 to flow to the first coolant bypass line 8 without passing through the radiator 228. That is, a flow of the PE coolant is controlled to bypass the radiator 228.

Additionally, the controller 12 is configured to control the opening state of the first valve 222 to allow the entire amount of PE coolant passing through the first coolant bypass line 8 to flow to the heat-exchange portion 155 in the flash tank 150.

That is, the first valve 222 is controlled to allow the first coolant bypass line 8 and the PE coolant line 7 on the inlet side of the heat-exchange portion 155 in the flash tank 150 to communicate with each other, and to block the PE coolant line 7 on the outlet side of the radiator 228.

Furthermore, the controller 12 is configured to control the second valve 223 to block all of the connected coolant lines, that is, the flow path of the second coolant bypass line 9 and the flow path of the connection line 10.

The controller 12 is configured to control the third valve 225 to block the PE coolant line 7 connected to the chiller 202 and to allow the PE coolant line 7 connected to the PE coolant passage portion 227 and the PE coolant line 7 connected to the water pump 221 to communicate with each other.

Accordingly, the PE coolant is discharged from the water pump 221 and then circulates along the paths of the PE coolant line 7, the first coolant bypass line 8, the first valve 222, the PE coolant line 7, the heat-exchange portion 155 of the flash tank 150, the PE coolant line 7, the PE coolant passage portion 227, the PE coolant line 7, the third valve 225, and the water pump 221.

In the battery thermal management system 210, the battery coolant circulates along the battery coolant line 6 to sequentially pass through the water pump 211, the battery coolant passage portion 213, and the chiller 202.

As described above, the battery coolant in the chiller 202 transfers waste heat from the battery 212 to the refrigerant through heat-exchange with the refrigerant (“BAT heat absorption”), and the refrigerant that has absorbed the waste heat from the battery 212 in the chiller 202 flows to the accumulator 180 through the chiller refrigerant line 4 and the refrigerant line 2.

Accordingly, in the first heating and dehumidification mode, while circulating along the circulation path of the refrigerant system, the refrigerant is primarily expanded by the second expansion valve 130 and then goes through a heat absorption (“PE heat absorption”) process in which the refrigerant absorbs heat from the coolant in the heat-exchange portion 155 of the flash tank 150. Thereafter, the refrigerant is secondarily expanded by the third expansion valve 201 and then goes through a heat absorption (“BAT heat absorption”) process in which the refrigerant absorbs waste heat from the battery 212 in the chiller 202.

Referring to the p-h diagram in FIG. 8, it may be seen that, in the first heating and dehumidification mode, distributed heat absorption through two-stage expansion, that is, first heat absorption and second heat absorption are performed together with first expansion and second expansion.

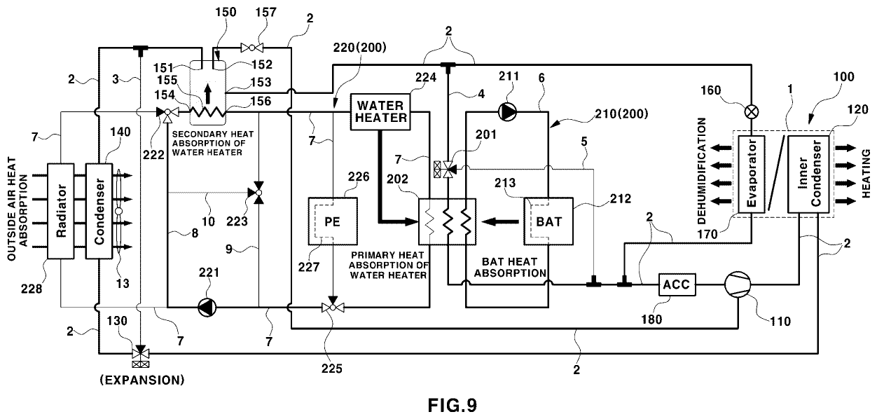

Next, FIG. 9 is a diagram showing a second heating and dehumidification mode of the thermal management system according to the exemplary embodiment of the present disclosure. FIG. 9 shows the circulation paths of refrigerant and coolant in a mode in which dehumidification is performed simultaneously with heating of the vehicle interior.

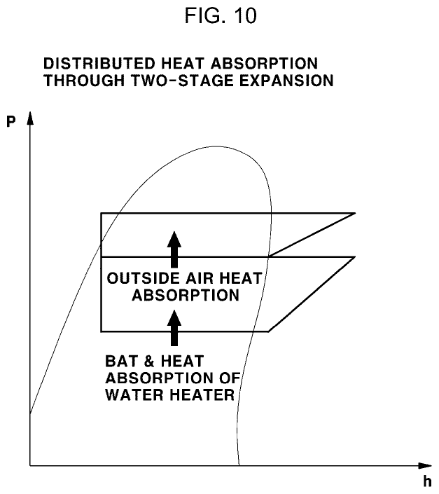

FIG. 10 is a p-h diagram showing that distributed heat absorption is performed through two-stage expansion of refrigerant in the second heating and dehumidification mode shown in FIG. 9.

In the second heating and dehumidification mode shown in FIG. 9, the vehicle interior is heated by operation of the heat pump, and the vehicle interior is heated by operation of the gas injection heat pump using the flash tank 150 and heat pump boosting by the water heater 224.

The second heating and dehumidification mode is performed to maximally improve, when the heat source is insufficient during operation of the heat pump in winter, heat pump heating performance by securing an additional heating heat source using the water heater 224.

In the second heating and dehumidification mode, circulation of the refrigerant and circulation of the battery coolant are similar to those in the first heating and dehumidification mode. However, in the second heating and dehumidification mode, the PE coolant is controlled to pass through the water heater 224 and the chiller 202 without passing through the PE coolant passage portion 227.

To the present end, the controller 12 is configured to control the opening state of the third valve 225 to allow the PE coolant line 7 on the outlet side of the chiller 202 and the PE coolant line 7 on the inlet side of the water pump 221 to communicate with each other. In the instant case, the opening state of the third valve 225 is controlled to block the PE coolant line 7 on the outlet side of the PE coolant passage portion 227.

Furthermore, in the first heating and dehumidification mode, the water heater 224 maintains the OFF state thereof. On the other hand, in the second heating and dehumidification mode, the water heater 224 is controlled to maintain the ON state thereof by the controller 12 to generate heat therefrom.

In the second heating and dehumidification mode, the PE coolant circulates along the paths of the water pump 221, the PE coolant line 7, the first coolant bypass line 8, the first valve 222, the PE coolant line 7, the heat-exchange portion 155 of the flash tank 150, the PE coolant line 7, the water heater 224, the PE coolant line 7, the chiller 202, the PE coolant line 7, the third valve 225, the PE coolant line 7, and the water pump 221.

Here, the PE coolant is heated in the water heater 224 and primarily transfers heat to the refrigerant while passing through the chiller 202 (“water heater primary heat absorption”). Accordingly, the PE coolant transfers heat to the refrigerant while passing through the heat-exchange portion 155 of the flash tank 150 (“water heater secondary heat absorption”). At the instant time, the heat of the PE coolant transferred to the refrigerant is the heat from the water heater 224.

A description will be provided as to a difference between “the first heating and dehumidification mode” and “the second heating and dehumidification mode”. In the first heating and dehumidification mode, the refrigerant absorbs, from the PE coolant passing through the heat-exchange portion 155, waste heat from the PE component 226 in the flash tank 150 and absorbs, from the battery coolant, waste heat from the battery 212 in the chiller 202.

On the other hand, in the second heating and dehumidification mode, the PE coolant passes through the heat-generating water heater 224 without passing through the PE coolant passage portion 227 and then passes through the chiller 202. Accordingly, the refrigerant primarily absorbs, from the PE coolant and the battery coolant, heat from the water heater 224 and waste heat from the battery 212 in the chiller 202. Accordingly, the refrigerant secondarily absorbs, from the PE coolant passing through the heat-exchange portion 155, heat from the water heater 224 in the flash tank 150.

Except for the present difference, the control state of the second heating and dehumidification mode is the same as that of the first heating and dehumidification mode. For example, there is no difference between the two modes in that the refrigerant is primarily expanded by the second expansion valve 130 and the refrigerant is secondarily expanded by the third expansion valve 201.

The p-h diagram in FIG. 10 shows a state in which, in the second heating and dehumidification mode, in addition to the distributed heat absorption through two-stage expansion, that is, primary expansion and secondary expansion of the refrigerant, “outside air heat absorption” in which the refrigerant absorbs heat from the outside air and “heat absorption” in which the refrigerant absorbs waste heat from the battery and heat from the water heater (“BAT & water heater heat absorption”) are performed.

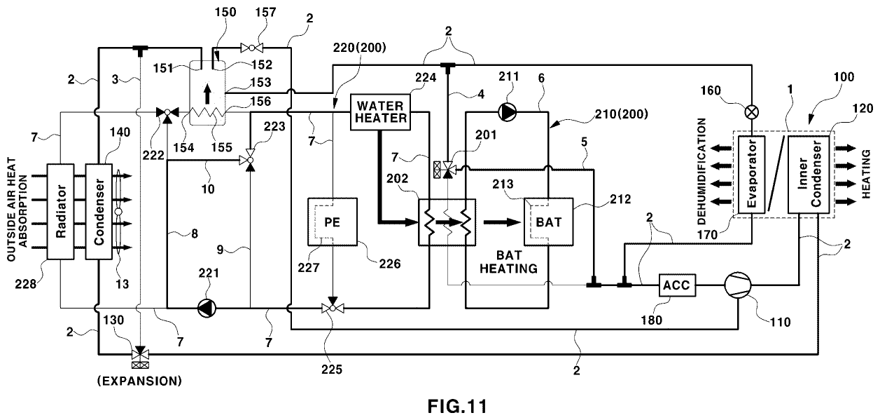

Next, FIG. 11 is a diagram showing a third heating and dehumidification mode of the thermal management system according to the exemplary embodiment of the present disclosure. FIG. 11 shows the circulation paths of refrigerant and coolant in a mode in which dehumidification is performed simultaneously with heating of the vehicle interior.

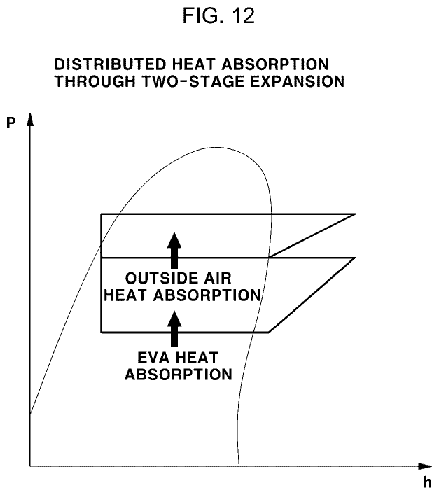

FIG. 12 is a p-h diagram showing a state in which distributed heat absorption is performed through two-stage expansion of refrigerant in the third heating and dehumidification mode shown in FIG. 11.

In the third heating and dehumidification mode shown in FIG. 11, heating of the vehicle interior is performed by operation of the heat pump, and heating of the vehicle interior is performed using heat pump boosting by the water heater 224.

The third heating and dehumidification mode is performed in a case where initial heating of the battery 212 is required during operation of the heat pump in winter, and may be referred to as a battery heating (“BAT heating”) mode in which the battery 212 is heated by heat from the water heater 224 so that the temperature of the battery 212 is increased.

In the third heating and dehumidification mode, a part of the refrigerant is distributed to the chiller refrigerant line 4 and then is supplied to the third expansion valve 201, which is the same as the first heating and dehumidification mode and the second heating and dehumidification mode.

However, in the third heating and dehumidification mode, the controller 12 is configured to control the third expansion valve 201 to expand the refrigerant to a low-temperature and low-pressure state and then discharge the expanded refrigerant to the second refrigerant bypass line 5. In the instant case, the flow path of the chiller inlet side is blocked in the third expansion valve 201, preventing the refrigerant from flowing to the chiller 202.

The refrigerant discharged from the third expansion valve 201 to the second refrigerant bypass line 5 is collected in the accumulator 180 through the refrigerant line 2 and then circulates again along the refrigerant line 2 by the compressor 110.

The second refrigerant bypass line 5 is the refrigerant line 2 configured to prevent the refrigerant from passing through the chiller 202, that is, the refrigerant line 2 configured to cause the refrigerant to bypass the chiller 202. Accordingly, when the third expansion valve 201 discharges the refrigerant to the second refrigerant bypass line 5, the refrigerant does not pass through the chiller 202 and accordingly, heat-exchange between the refrigerant and the coolant is not performed in the chiller 202.

At the present time, only heat-exchange between the PE coolant and the battery coolant is performed in the chiller 202, and heat from the PE coolant heated by the water heater 224 is transferred from the chiller 202 to the battery coolant. Accordingly, while passing through the battery coolant passage portion 213, the battery coolant heats the battery 212 to increase the temperature of the battery 212 (“BAT heating”).

In the third heating and dehumidification mode, the circulation path of the remaining refrigerant is similar to that of the second heating and dehumidification mode, except that the refrigerant distributed to the chiller refrigerant line 4 is not supplied to the chiller 202 and flows to the second refrigerant bypass line 5.

That is, the refrigerant discharged from the compressor 110 sequentially passes through the internal condenser 120 (“heating”), the second expansion valve 130 (“expansion”), and the external condenser 140 (“outside air heat absorption”). Thereafter, the refrigerant is injected into the flash tank 150. Here, the gaseous refrigerant in the flash tank 150 is discharged to the first refrigerant outlet 152. Accordingly, the gaseous refrigerant is drawn by and transferred from the compressor 110 through the outlet valve 157, circulating again along the circulation path of the refrigerant system.

Furthermore, after the liquid refrigerant in the flash tank 150 is discharged to the second refrigerant outlet 153, a portion of the refrigerant moves to the first expansion valve 160, the evaporator 170, (“dehumidification”), and the accumulator 180. Here, the remaining refrigerant is distributed to the chiller refrigerant line 4, passes through the third expansion valve 201, and then moves to the accumulator 180 along the second refrigerant bypass line 5. Accordingly, the refrigerant collected in the accumulator 180 is drawn by and transferred from the compressor 110 again, circulating along the circulation path of the refrigerant system. In the instant case, the first expansion valve 160 and the third expansion valve 201 expand the refrigerant.

At the same time, the battery coolant circulates along the battery coolant line 6 between the water pump 211, the battery coolant passage portion 213, and the chiller 202. In the chiller 202, the battery coolant receives heat from the water heater 224 through heat-exchange with the PE coolant heated by the water heater 224, and then heats the battery 212 while passing through the battery coolant passage portion 213.

The PE coolant circulates along the paths of the water pump 221, the PE coolant line 7, the first coolant bypass line 8, the connection line 10, the second valve 223, the second coolant bypass line 9, the PE coolant line 7, the water heater 224, the PE coolant line 7, the chiller 202, the PE coolant line 7, the third valve 225, the PE coolant line 7, and the water pump 221.

In the third heating and dehumidification mode, the PE coolant bypasses the radiator 228 and the heat-exchange portion 155 of the flash tank 150 without passing therethrough. Thereafter, the PE coolant is heated while passing through the water heater 224 configured to generate heat therefrom. Accordingly, the PE coolant is supplied to the chiller 202 and transfers heat to the battery coolant while passing through the chiller 202.

In the present manner, in the third heating and dehumidification mode, to allow the coolant to bypass the radiator 228 and the heat-exchange portion 155 of the flash tank 150, the controller 12 is configured to control the first valve 222 to close and block all of the flow paths of the connected coolant lines, that is, the PE coolant line 7 on the outlet side of the radiator 228, the PE coolant line 7 on the coolant inlet side 154 of the flash tank 150, and the first coolant bypass line 8.

Referring to the p-h diagram in FIG. 12, in the third heating and dehumidification mode, “distributed heat absorption” through two-stage expansion of the refrigerant, that is, heat absorption in the evaporator 170 (“EVA heat absorption”, the refrigerant absorbs heat from the air-to-be-conditioned) and “heat absorption” in the external condenser 140 (“outside air heat absorption”, the refrigerant absorbs heat from the outside air) are performed.

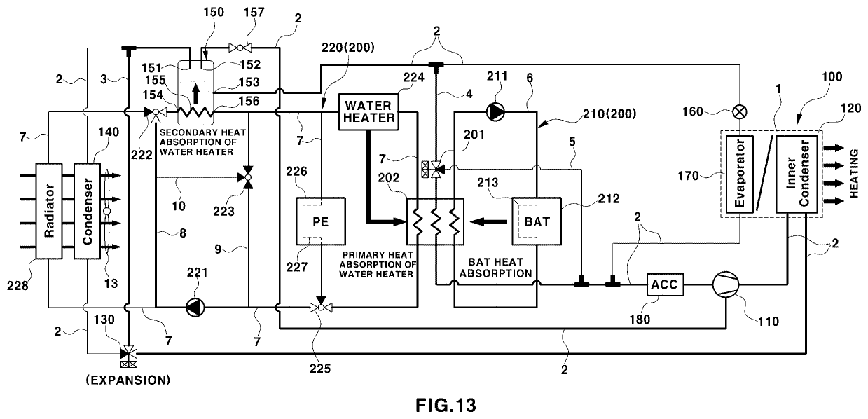

Next, FIG. 13 is a diagram showing a heat pump heating mode of the thermal management system according to the exemplary embodiment of the present disclosure. FIG. 13 shows the circulation paths of refrigerant and coolant in a mode in which vehicle interior heating is performed through gas injection one-stage expansion.

FIG. 12 is a p-h diagram showing a state in which one-stage expansion of refrigerant and battery heat absorption (“BAT heat absorption”) are performed in the heat pump heating mode shown in FIG. 11.

In the heat pump heating mode shown in FIG. 12, the vehicle interior heating is performed by operation of the heat pump, and vehicle interior is heated by operation of the gas injection heat pump using the flash tank 150 and heat pump boosting by the water heater 224.

The heat pump heating mode shown in FIG. 12 is not gas injection two-stage expansion but an operation mode of the heat pump through one-stage expansion. Furthermore, the heat pump heating mode may be selected when the external condenser 140 is required to be defrosted.

As described above, since the heat pump heating mode is a mode performed when the external condenser 140 is required to be defrosted, in the heat pump heating mode shown in the drawing, the refrigerant is controlled to bypass the external condenser 140 without passing therethrough, and the refrigerant passing through the second expansion valve 130 is controlled to flow to the first refrigerant bypass line 3 instead of the path passing through the external condenser 140.

To the present end, the second expansion valve 130 is controlled to expand the refrigerant to a low-temperature and low-pressure state and is also controlled to discharge the expanded refrigerant to the first refrigerant bypass line 3. The controller 12 is configured to control the second expansion valve 130 to allow the refrigerant line 2 on the outlet side of the internal condenser 120 and the first refrigerant bypass line 3 to communicate with each other and to block the refrigerant line 2 on the inlet side of the external condenser 140.

In more detail, the high-temperature and high-pressure refrigerant compressed by and transferred from the compressor 110 moves along the refrigerant line 2, passes through the internal condenser 120, and is supplied to the second expansion valve 130.

In the instant case, the refrigerant exchanges heat with air-to-be-conditioned while passing through the internal condenser 120, and conditioned air heated through such heat-exchange is discharged into the vehicle interior, heating the vehicle interior.

Furthermore, the refrigerant is expanded to a low-temperature and low-pressure state while passing through the second expansion valve 130. Thereafter, the expanded refrigerant is discharged from the second expansion valve 130 to the first refrigerant bypass line 3 so as not to pass through the external condenser 140.

Accordingly, the refrigerant passing through the first refrigerant bypass line 3 is injected into and collected in the flash tank 150. Here, in the flash tank 150, heat-exchange is performed between the PE coolant that has been heated by the water heater 224 and has passed through the heat-exchange portion 155 and the refrigerant.

In the instant case, the heat of the PE coolant is transferred to the refrigerant in the flash tank 150. Here, the PE coolant that exchanges heat with the refrigerant is coolant which is heated while passing through the water heater 224 and then is moved to the flash tank 150 along the PE coolant line 7 and the first coolant bypass line 8 to pass through the heat-exchange portion 155.

In the flash tank 150, gaseous refrigerant and liquid refrigerant are separated from each other. The separated gaseous refrigerant is discharged to the refrigerant line 2 through the first refrigerant outlet 152, and then passes through the outlet valve 157. Thereafter, the gaseous refrigerant is drawn into the compressor 110 to secure a flow rate of the refrigerant.

Furthermore, the low-temperature liquid refrigerant in the flash tank 150 is discharged to the refrigerant line 2 through the second refrigerant outlet 153 and then is moved to the chiller refrigerant line 4. Accordingly, after passing through the third expansion valve 201, the refrigerant is supplied to the chiller 202 in which the refrigerant exchanges heat with the battery coolant and the PE coolant.

In other words, the refrigerant in the chiller 202 absorbs waste heat from the battery 212 through the battery coolant and heat from the water heater 224 through the PE coolant. Through the present process, the heat pump operation of the one-stage expansion of the gas injection may be performed.

The battery coolant circulation path in the battery thermal management system 210, the PE coolant circulation path in the PE thermal management system 220, the operation of each of the water pumps 211 and 221, the heat generation operation of the water heater 224, and the control state of each of the first valve 222, the second valve 222, and the third valve 225 are not different from those of the second heating and dehumidification mode shown in FIG. 9, so a detailed description thereof will be omitted.

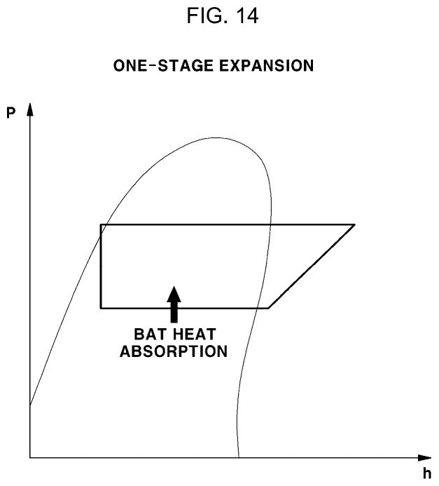

Referring to a p-h diagram in FIG. 14, the p-h diagram shows a state in which one-stage expansion of the refrigerant and waste heat absorption of the battery 212 (“BAT heat absorption”) are performed in the heat pump heating mode shown in FIG. 11.

As is apparent from the above description, the present disclosure provides a vehicle thermal management system configured not only to employ a gas injection heat pump system for vehicle interior heating, vehicle interior cooling, battery cooling, and the like, but also to perform additional heat dissipation in response to an increase in heat load of a vehicle.

A water-cooled condensing technique utilizing a flash tank of a gas injection heat pump is provided, making it possible not only to additionally secure a subcooled area to increase an amount of heat dissipation, but also to effectively solve a heat load problem in an electric vehicle. In the present manner, marketability of an electric vehicle may be improved.

Additionally, a high-temperature and high-pressure state in a refrigerant system may be effectively stabilized, and internal cooling performance, battery cooling performance, and the like may be improved. Furthermore, since a single component such as an electric heater is eliminated, the number of parts is reduced, reducing vehicle manufacturing costs.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle thermal management system comprising:
a refrigerant system including an external condenser and a first expansion valve connected by a refrigerant line and configured to cause, while a refrigerant circulates along the refrigerant line, the refrigerant to sequentially pass through the external condenser and the first expansion valve along the refrigerant line;
a component thermal management system including a battery or a power electric (PE) component connected by a coolant line and configured to perform, using the refrigerant distributed from the refrigerant system and a coolant circulating along the coolant line, thermal management on the battery or the power electric (PE) component; and
a heat-exchanger including a heat-exchange portion connected to the coolant line and provided to allow the coolant circulating through the component thermal management system to pass through the heat-exchange portion,
wherein the heat-exchanger is provided on the refrigerant line between the external condenser and the first expansion valve and performs heat-exchange between the coolant passing through the heat-exchange portion and the refrigerant injected from the refrigerant line.

2. The vehicle thermal management system of claim 1,
wherein the component thermal management system further includes a PE thermal management system configured to perform the thermal management on the PE component,
wherein the coolant line includes a PE coolant line connected to the heat-exchange portion of the heat-exchanger, and
wherein the PE thermal management system includes:
a first water pump configured to circulate PE coolant;
a water heater configured to heat the PE coolant;
a PE coolant passage portion provided in the PE component and configured to allow the PE coolant to pass through the PE coolant passage portion;
a radiator configured to perform heat-exchange between the PE coolant and air; and
the PE coolant line connecting the first water pump, the water heater, the PE coolant passage portion, and the radiator to each other, wherein the PE coolant circulates along the PE coolant line.

3. The vehicle thermal management system of claim 2, wherein the component thermal management system further includes:
a chiller refrigerant line connected to the refrigerant line of the refrigerant system to allow the refrigerant of the refrigerant system to be distributed to and flow through the chiller refrigerant line;
a chiller including the PE coolant line connected to the chiller and the chiller refrigerant line connected to the chiller, wherein the chiller performs heat-exchange between the PE coolant and the refrigerant flowing through the chiller refrigerant line; and
a third expansion valve provided on the chiller refrigerant line on a refrigerant inlet side of the chiller.

4. The vehicle thermal management system of claim 3,
wherein the component thermal management system further includes a battery thermal management system configured to perform the thermal management on the battery,
wherein the coolant line includes a battery coolant line, and
wherein the battery thermal management system includes:
a second water pump configured to circulate a battery coolant;
a battery coolant passage portion provided in the battery and configured to allow the battery coolant to pass through the battery coolant passage; and
the battery coolant line connecting the second water pump to the battery coolant passage, wherein the battery coolant circulates along the battery coolant line.

5. The vehicle thermal management system of claim 4,
wherein the battery coolant line is connected to the chiller, and
wherein the chiller is provided to perform, while allowing two or three of the refrigerant of the chiller coolant line, the PE coolant of the PE coolant line, and the battery coolant of the battery coolant line to pass through the chiller, the heat-exchange between the two or three.

6. The vehicle thermal management system of claim 3,
wherein the component thermal management system further includes a refrigerant bypass line branching from the chiller refrigerant line on an inlet side of the chiller and connected to the chiller refrigerant line on an outlet side the chiller to bypass the chiller, and
wherein the third expansion valve formed as a three-way valve and configured to expand the refrigerant is provided at a location allowing the refrigerant bypass line to branch from the chiller refrigerant line on the inlet side of the chiller, allowing the refrigerant discharged from the third expansion valve to selectively flow through the chiller and the refrigerant bypass line.

7. The vehicle thermal management system of claim 3, wherein the outlet side of the chiller is connected to an accumulator of the refrigerant system through the refrigerant line, allowing the refrigerant passing through the chiller to flow into the accumulator.

8. The vehicle thermal management system of claim 7, further including a compressor connected between the heat exchanger and the accumulator and configured to compress and discharge the refrigerant from the refrigerant line.

9. The vehicle thermal management system of claim 3, wherein the chiller refrigerant line branches from the refrigerant line between a refrigerant outlet configured to allow the refrigerant in the heat-exchanger to be discharged through the refrigerant outlet and the first expansion valve, allowing the refrigerant discharged from the heat-exchanger to be distributed to the chiller refrigerant line and to flow through the chiller refrigerant line.

10. The vehicle thermal management system of claim 2,
wherein the heat-exchanger includes a coolant inlet configured to allow the coolant to flow into the heat-exchange portion through the coolant inlet, and a coolant outlet configured to allow the coolant passing through the heat-exchange portion to be discharged through the coolant outlet,
wherein the coolant inlet is connected to the coolant line on an outlet side of the radiator, and
wherein the coolant outlet is connected to the coolant line on an inlet side of the water heater and an inlet side of the PE coolant passage portion.

11. The vehicle thermal management system of claim 2,
wherein the heat-exchanger includes a coolant inlet configured to allow the coolant to flow into the heat-exchange portion through the coolant inlet, and a coolant outlet configured to allow the coolant passing through the heat-exchange portion to be discharged through the coolant outlet, and
wherein the PE management system further includes:
a first coolant bypass line connecting the coolant line on an outlet side of the first water pump to the coolant line connected to the coolant inlet of the heat-exchanger to bypass the radiator; and
a first valve provided at a location allowing the first coolant bypass line to be connected to the coolant line on an inlet side of the radiator and configured to control a flow of the coolant.

12. The vehicle thermal management system of claim 11,
wherein the PE thermal management system further includes:
a second coolant bypass line connecting the coolant line on an inlet side of the first water pump to the coolant line connected to the coolant outlet of the heat-exchanger;
a connection line connecting the first coolant bypass line to the second coolant bypass line; and
a second valve provided on the connection line and the second coolant bypass line and configured to control flow of the coolant so that the coolant selectively flows through the connection line.

13. The vehicle thermal management system of claim 12, wherein the second valve is a three-way valve provided at a location allowing the connection line to be connected to the second coolant bypass line.

14. The vehicle thermal management system of claim 3, wherein the PE thermal management system further includes a three-way valve configured to control a flow of the coolant between the coolant line on an outlet side of the PE coolant passage portion, the coolant line on an outlet side of the chiller, and the coolant line on an inlet side of the first water pump.

15. The vehicle thermal management system of claim 1,
wherein the heat-exchanger includes the heat-exchange portion provided in the heat-exchanger,
wherein the heat-exchanger includes a refrigerant inlet configured to allow the refrigerant to flow into the heat-exchanger therethrough the refrigerant inlet, and a first refrigerant outlet and a second refrigerant outlet each configured to allow the refrigerant present in the heat-exchanger to be discharged through the first refrigerant outlet and the second refrigerant outlet, and
wherein the refrigerant inlet is connected to the refrigerant line on an outlet side of the external condenser.

16. The vehicle thermal management system of claim 15,
wherein the first refrigerant outlet is connected to the refrigerant line on an inlet side of a compressor configured to compress and discharge the refrigerant from the refrigerant system, and
wherein the second refrigerant outlet is connected to the refrigerant line on an inlet side of the first expansion valve.

17. The vehicle thermal management system of claim 16,
wherein the first refrigerant outlet is provided at an upper portion of the heat-exchanger to discharge, from an inside of the heat-exchanger, gaseous refrigerant separated through gas-liquid separation of the refrigerant,
wherein the second refrigerant outlet is provided at a lower portion of the heat-exchanger to discharge liquid refrigerant, and
wherein the first refrigerant outlet includes an outlet valve provided on an outlet side of the first refrigerant outlet, wherein the outlet valve maintains an opened state thereof to allow the gaseous refrigerant to be drawn into the compressor from the inside of the heat-exchanger through the first refrigerant outlet.

18. The vehicle thermal management system of claim 1, wherein the heat-exchanger is a flash tank including a refrigerant inlet and a refrigerant outlet, and the heat-exchange portion is disposed on a lower side inside the flash tank.

19. The vehicle thermal management system of claim 1, further including:
a refrigerant bypass line connecting the refrigerant line on an inlet side of the external condenser to the refrigerant line on an outlet side of the external condenser to bypass the external condenser,
wherein a second expansion valve formed as a three-way valve and configured to selectively expand the refrigerant is provided at a location allowing the refrigerant line on the inlet side of the external condenser to be connected to the refrigerant bypass line.
